(19) United States
(12) Patent Application Publication
(10) Pub. No.: US 2006/0290651 A1
(43) Pub. Date: Dec. 28, 2006

(54) Electrooptic/micromechanical display with discretely controllable bistable transflector

(76) Inventors: Nynke A. M. Verhaegh, Eindhoven (NL); Dirk K. G. De Boer, Den Bosch (NL); Mark T. Johnson, Veldhoven (NL); Bas Van Der Heijden, Hoogeloon (NL)

Correspondence Address: PHILIPS INTELLECTUAL PROPERTY & STANDARDS, P.O. BOX 3001, BRIARCLIFF MANOR, NY, 10510, US

(21) Appl. No.: 10/572,843

(22) PCT Filed: Sep. 9, 2004
(86) PCT No.: PCT/IB04/51730

§ 371 Date: Mar. 21, 2006

(30) Foreign Application Priority Data
Sep. 23, 2003 (GB) 0322229.6

(51) Int. Cl. G09G 3/34

(52) U.S. Cl. 345/107

(57) ABSTRACT

A display (1) comprises a display device (2), such as an LC cell and a switchable transflector (7). The transflector 7 comprises a plurality of discrete portions and is configured so that the transmittance and reflectance properties of at least one of said portions can be tuned independently of other portions. Where the transflector is a suspended particle device (SPD), the portions may comprise individual particle suspensions (8a, 8b, 8c) and/or regions within a cell containing a particle suspension (8a, 8b, 8c). In normal operation, images etc. are displayed using the display device (2). In some embodiments, the transflector (7) may be used in the provision of illumination for the display device (2) using backlighting 9 from light source (3) and/or reflected ambient light (10), in dependence on the light level detected by a light sensor (22). The transflector 7 may be used to display images (23) or text, such as touch screen keys (24) while the display (1) is in standby mode and the display device (2) is switched off.

The invention relates to a display comprising a first display device and a transflector that is suitable for use as a second display device.

Displays for devices such as personal computers, personal digital assistants (PDAs), mobile telecommunications devices or similar may be required to operate in a stand-by mode when the device is not in constant use. This may include running a “screensaver”, an application that displays a moving image or series or images. This measure avoids the display of a static image for an extended period of time, which could lead to image retention, or “burn-in”, where the display includes a cathode ray tube (CRT) or plasma screen, but is also commonly used in displays comprising a liquid crystal display (LCD) device.

Additionally, or alternatively, the display may be switched off, in order to reduce its power consumption. This may be an important consideration where the display forms part of a portable or mobile device, which may be required to operate on limited battery power.

However, there may be particular applications where the display of a static image when in standby mode is required. For instance, where the device comprises a touch-screen interface, it may be desirable to maintain an image of a keypad on the display.

According to a first aspect of the invention, a display comprises a display device and a transfiector, wherein the transflector comprises a plurality of discrete portions and is configured so that the transmittance and reflectance properties of at least one of said portions can be tuned independently of other portions.

The provision of a transflector divided into a number of portions that can be selectively tuned allows an image and/or text to be displayed by switching the appropriate portions into reflective or transmissive states. The image is then viewable as ambient light is reflected by the reflective portions. As the power requirements of the transfiector may be lower than those of the first (main) display device, the transflector can be used as a second display device when the main display device is in a relatively low-power operating mode, such as a standby mode. Thus, a display may be provided that is capable of standby mode imaging in a reduced power consumption mode while avoiding the problem of image retention. The transfiector may also be used as a second display device in conjunction with the main display device during normal operation in order to reduce power consumption and/or prevent burn-in of the main display device. For example, the transflector may be used to display touch screen keys.

The transflector is preferably a bistable device. In other words, the transfiector may be capable of remaining in a given state for a significant period of time following the removal of power when the display is switched into standby mode. For example, where the transfiector is a suspended particle device (SPD), a transmissive, intermediate or reflective state can be achieved by controlling particles within the SPD using an electric field, so that the particle alignment is substantially uniform along the field direction. When the display is switched into a standby mode, the electric field is removed. As the particles are now free to undergo Brownian motion, the uniformity of the particle alignments begins to decay. The alignments of the particles become random and disordered, over a period of time referred to hereafter as a relaxation time. Where the relaxation time is considerable, for example, greater than five minutes, the SPD may be considered to be a bistable device.

If the transflector is bistable, images can be displayed without requiring a continuous supply of power, further reducing the power requirements of the display when presenting images in a standby mode.

The transflector may be a suspended particle device in which portions are formed by cells containing separate particle suspensions. Alternatively, or additionally, the transfiector may be a suspended particle device in which portions are defined by spatial regions within a compartment housing a particle suspension. An image may then be displayed by the suspended particle device by using the portions as pixels and tuning the transmittance and reflectance properties of the portions accordingly. The portions may be configured so that they can be tuned to a transmitting state or a reflecting state and may further be configured to allow a portion to be tuned to an intermediate state.

The transmittance and reflectance of a particle suspension within a SPD is governed by the alignment of its particles. The particle alignment can be controlled using one or more electric fields. When an electric field is applied to a particle suspension, a dipole is induced in the particles, causing them to minimise energy by aligning themselves in the direction of the electric field. Following removal of the electric field, the particles undergo Brownian motion and the substantially uniform particle alignment deteriorates. Where the relaxation time is considerable, that is, where the SPD is a bistable device, an image displayed by the suspended particle device may be retained for a significant period of time after the electric field is removed.

Preferably, the transflector is a suspended particle device arranged to allow two mutually orthogonal electric fields to be applied to a particle suspension simultaneously. This allows the transflector to be switched into highly transmissive and/or highly reflective states by applying one or more electric fields to the particle suspension that equal or exceed a saturation potential of the particle suspension. The saturation potential for a particle suspension is defined as the minimum potential that, when applied to the particle suspension, causes the particles to be aligned parallel to the electric field. The transflector may be further arranged so that both fields may be applied simultaneously, in order to attract the particles against a surface that partially encloses the particle suspension. In this state, the transflector has a particularly high reflectivity.

The transflector may be configured so that the transmittance and reflectance properties of the portions may be tuned to intermediate, or grey, values, between those associated with highly transmissive and highly reflective states by, for example, applying one or more non-saturating potentials to the particle suspension or by applying two or more electric fields to the particle suspension intermittently, according to a predetermined driving scheme.

Where the transflector is a suspended particle device arranged so that two or more electric fields may be applied to a particle suspension, the transflector may be arranged to “reset” a particle alignment arising from the application of a first electric field with a first field direction by applying a second electric field with a second field direction.

Where the transfiector comprises a SPD, an active matrix may be provided for use in applying electric fields.

Optionally, where the transfiector is a SPD, it may be configured to apply an electric field to a particle suspension intermittently, in order to maintain particle alignment. As a relaxation time associated with the particle alignment may be considerable, this arrangement allows an image displayed by the transflector to be maintained for an extended period of time with low power requirements.

The transflector may be arranged so that the dimensions of the discrete portions are non-identical (different). In particular, where the transflector is intended to display a predetermined image, the discrete portions may be configured accordingly.

The display device may be a liquid crystal cell, an electrophoretic device, an electrowetting device, an electrochromic device or a micromechanical display. In embodiments including such display devices, the transfiector may be placed between the display device and an associated source of backlighting, or on the opposite side, that is, in front of, the display device. Alternatively, the display device may be an emissive device, such as a cathode ray tube (CRT), organic light-emitting diode (OLED) display, a polymer light-emitting diode (poly-LED) display or a plasma screen, in which case, the transfiector may be placed in front of the display device.

The transflective display may further comprise a touch screen arrangement.

This aspect of the invention further provides a user interface comprising the transflective display and a touch screen arrangement.

According to a second aspect of the invention, a method of displaying an image on a transflective display, which includes a display device and a transfiector, comprises tuning the transmittance and reflectance properties of at least one of a plurality of discrete portions of the transflector independently of other portions.

Embodiments of the invention will now be described with reference to the accompanying drawings, in which:

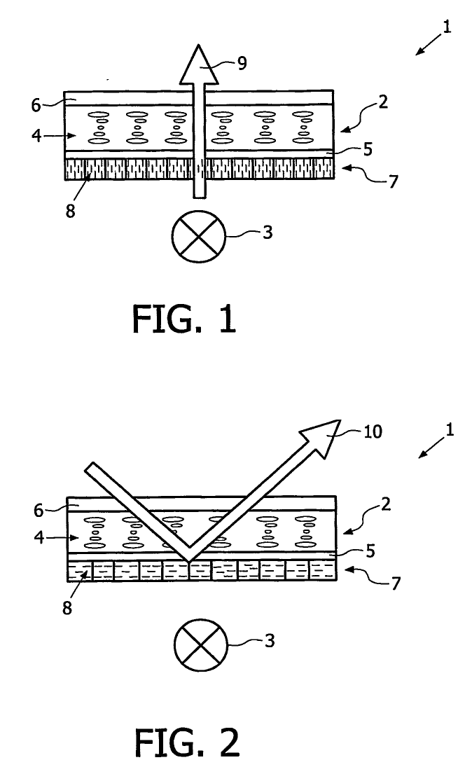

FIG. 1 is a schematic diagram of a transflective display according to a first embodiment of the present invention, comprising a transflector in a transmissive state;

FIG. 2 is a schematic diagram of the transflective display of FIG. 1 where the transflector is in a reflective state;

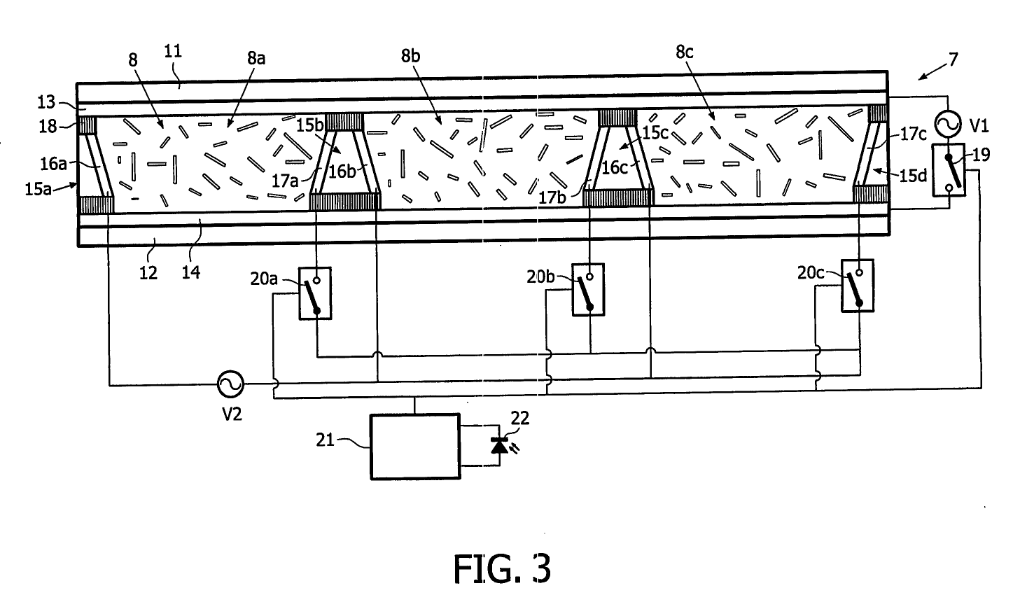

FIG. 3 is a cross-sectional view of the transflector in the display of FIG. 1 in a relaxed state;

FIG. 4 is a cross-sectional view of the transflector in the display of FIG. 1 in a transmissive state;

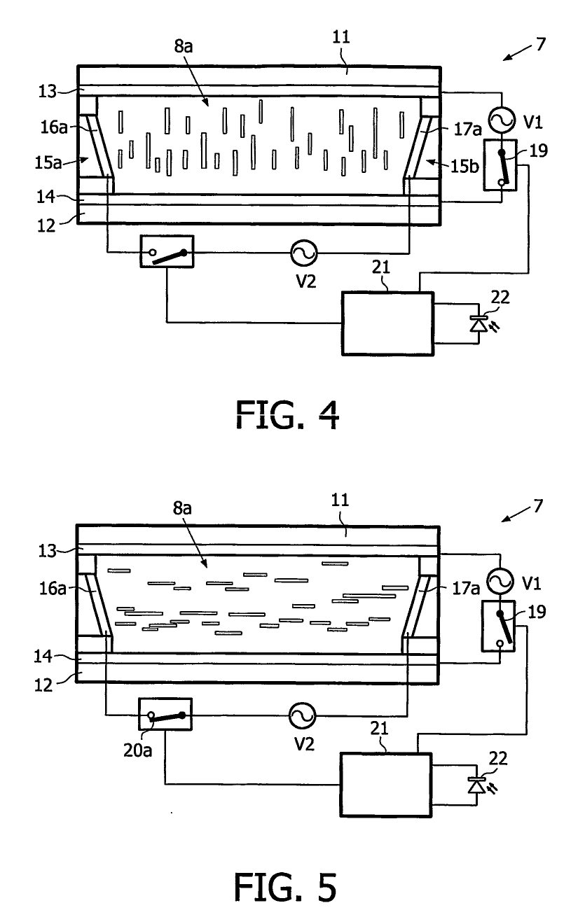

FIG. 5 is a cross-sectional view of the transflector in the display of FIG. 1 in a reflective state;

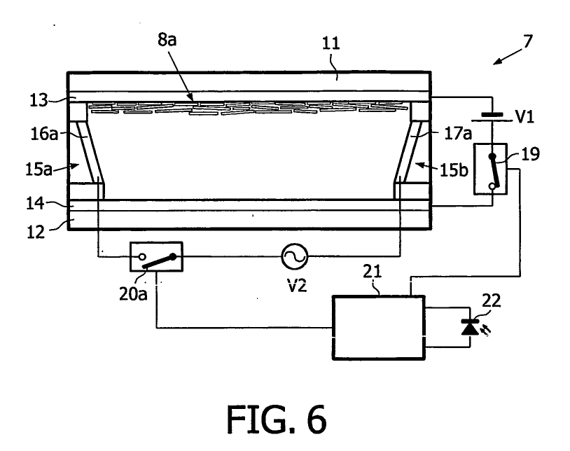

FIG. 6 is a cross-sectional view of the transflector in the display of FIG. 1 in an enhanced reflective state;

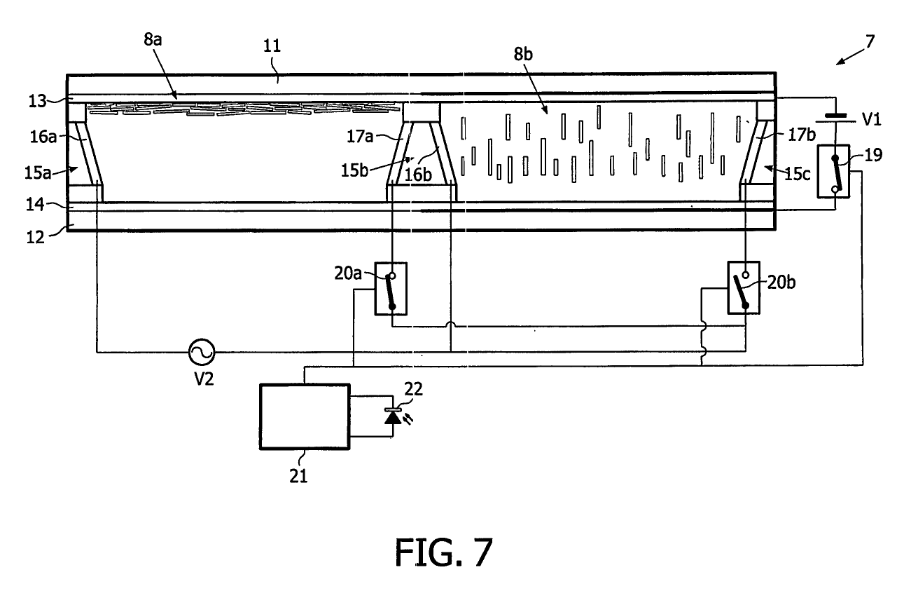

FIG. 7 is a cross-sectional view showing two cells within the transfiector of FIG. 2 in different states;

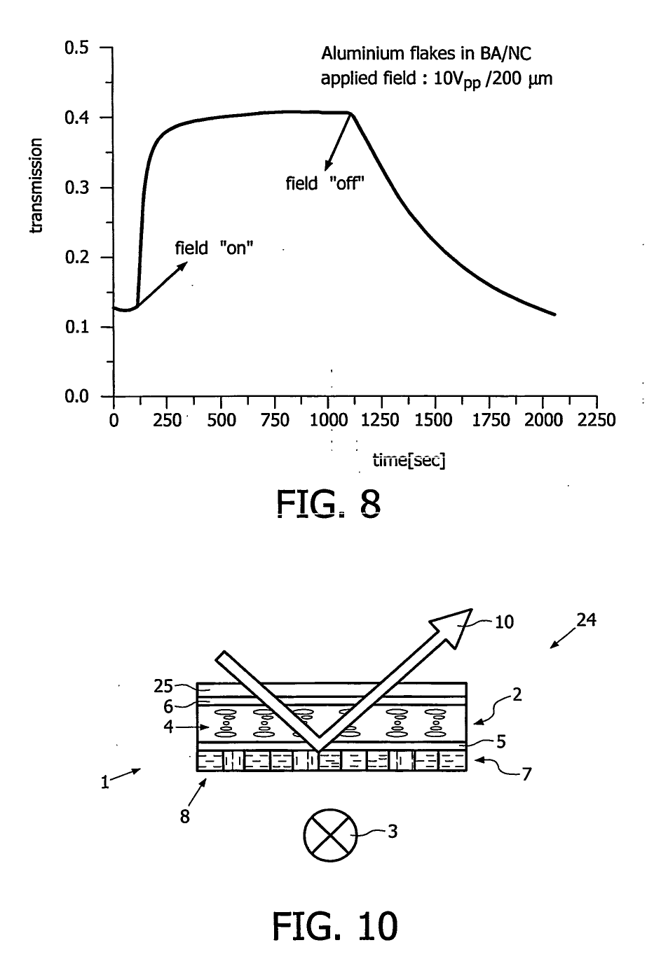

FIG. 8 is a graph of experimental data showing decay of transmittance properties in a particle suspension following the removal of an electric field;

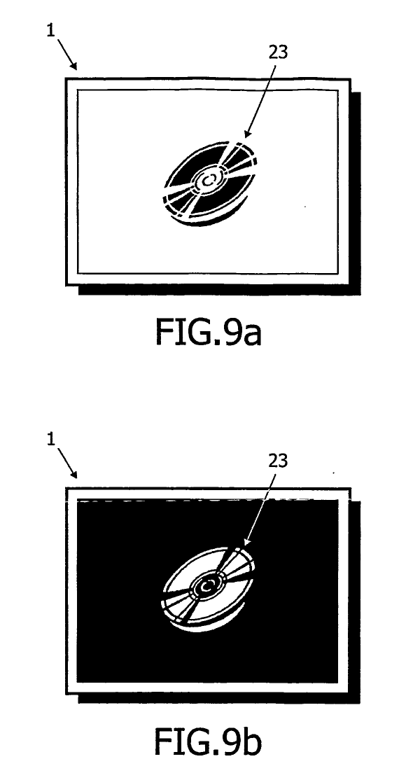

FIGS. 9a and 9b depict images displayed by the transfiector in the display of FIG. 1 using alternative methods according to the present invention;

FIG. 10 is a schematic diagram of a user interface incorporating the display of FIG. 1;

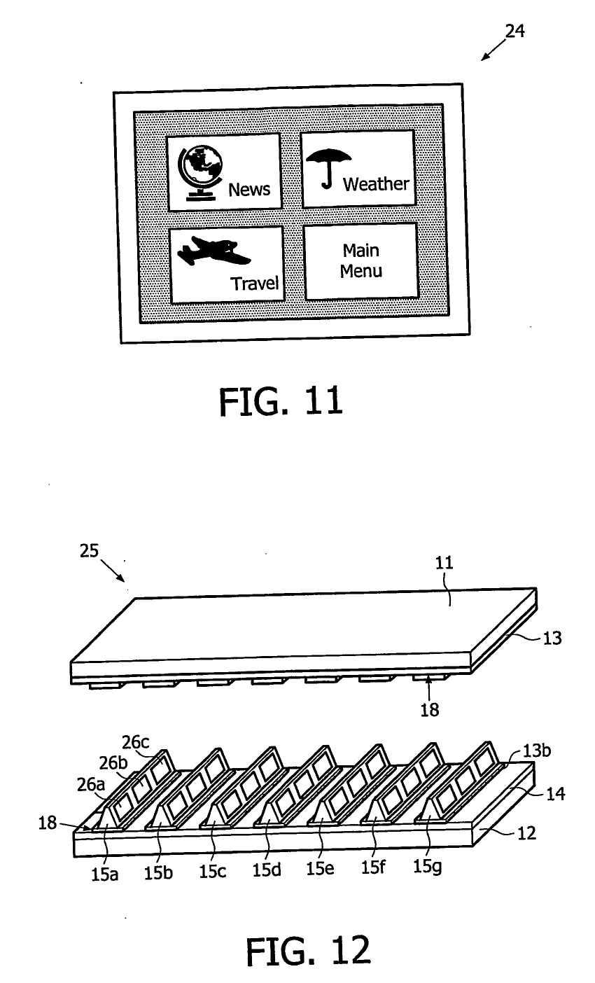

FIG. 11 depicts an image displayed by the transfiector when used in the user interface of FIG. 10; and

FIG. 12 is a schematic diagram of a suspended particle device that may be used as a transfiector in an alternative embodiment of the invention.

Referring to FIGS. 1 and 2, a transflective display 1 according to the present invention comprises a display device, such as a liquid crystal (LC) cell, indicated generally as 2, and an associated light source 3. When the display 1 is in operation, the LC cell 2 is used to display images. If the display 1 is switched into a standby mode, the power supply to the display 1 is switched off and any image displayed by the LC cell 2 rapidly decays. If required, the LC cell 2 may display a screensaver for a predetermined period of time before the power supply is switched off.

The LC cell 2 comprises liquid crystal material 4 held between two plates 5, 6, together with driving means, such as a matrix of column (select) and row (addressing) electrodes or a matrix of thin-film transistors, not shown. The structure and operation of such an LC cell 2 is well known per se.

A transflector, in the form of a suspended particle device (SPD) 7 comprising a particle suspension 8, is positioned so that light 9 emitted by the light source 3 must pass through a particle suspension 8 before entering the LC cell 2. The SPD 7 is capable of transmitting light 9 emitted by the light source 3 and reflecting ambient light 10 that enters the display 1 and passes through the LCD cell 2. The SPD 7 is further arranged to display images when the display 1 is in a standby mode.

FIG. 3 shows a portion of the SPD 7 in greater detail. The particle suspension 8 is sandwiched between a plate 11 and a substrate 12. The plate 11 and substrate 12 are made of an insulating transparent material. Suitable materials for forming the plate 11 and/or substrate 12 include glass, quartz, plastic and silicon oxide (SiO₂). In this example, the thicknesses of the plate 11 and substrate 12 are approximately 700 μm. Both the plate 11 and substrate 12 are coated with a layer of conducting material 13, 14. In this particular embodiment, the layers 13, 14 are formed using indium fin oxide (ITO) deposited in a CVD or sputtering process. Spacers 15a to 15d are provided in order to maintain a constant gap between the plate 11 and substrate 12 and to divide the suspended particle device 7 into an array of cells. In this example, the gap between the plate 11 and substrate 12 is 200 μm and the width of the cells, that is, the interval between adjacent spacers 15a to 15d is also 200 m. However, the SPD 7 may be configured with other gap sizes and cell widths within a range of 20 to 800 μm and it is not essential for the gap and cell widths to correspond to each other.

In this embodiment, the particle suspension 8 is divided between the cells to form separate particle suspensions 8a, 8b, 8c. Each particle suspension 8a to 8c comprises a plurality of anisometric reflective particles suspended in an insulating fluid. Examples of suitable particles include metallic platelets of silver, aluminum or chromium, mica particles or particles of an inorganic titanium compound. Regarding the physical dimensions of the particles, their lengths are of order of 1 to 50 μm and their thicknesses are within a range of 5 to 300 nm. In this particular example, the particles have a typical length of 10 μm and a thickness of 30 nm. The suspension fluid may. be butylacetate or a liquid organosiloxane polymer with a viscosity that permits Brownian motion of the particles but prevents sedimentation.

The spacers 15a to 15d are coated with ITO layers 16a to 16c, 17a to 17c and are isolated from the ITO layers 13, 14 on the plate 11 and substrate 12 by thin SiO₂ passivation layers 18. The passivation layers 18 are indicated using shading in FIG. 3. The passivation layers 18 do not cover the whole area of the plate 11 and substrate 12 in order to prevent potential drops between each ITO layer 13, 14 and particle suspensions 8a, 8b, 8c being formed across them.

The ITO layers 13, 14, 16a to 16c, 17a to 17c form electrodes that can be used to apply one or more electric fields to the particle suspensions 8a, 8b, 8c. Although a potential drop will exist across the passivation layer 18, between each ITO layer 13, 14 and ITO layers 16a to 16c, 17a to 17c, this is taken into account when applying voltages to the particle suspensions 8a, 8b, 8c and/or configuring driving schemes for the SPD 7.

The SPD 7 comprises circuitry for applying a first voltage V1 to electrodes 13, 14, comprising a first switch 19, and circuitry for applying a second voltage V2 to electrodes 16a to 16c, 17a to 17c, comprising second switches 20a, 20b, 20c.

The SPD 7 is connected to a control unit 21. The control unit 21 receives data from a light sensor, such as a photodiode 22, which detects the level of ambient light 10 in the vicinity of the SPD 7. The control unit 21 determines a desired reflectance or transmittance state for the particle suspension 8 on the basis of data output by the photodiode 22 and applies suitable voltages V1, V2 as required.

In FIG. 3, switches 19, 20a, 20b, 20c are open, so that no electric fields are applied to the particle suspensions 8a, 8b, 8c. The particles have random alignments that vary over time, due to Brownian motion. The particle suspensions 8a, 8b, 8c are semi-opaque, or opaque, depending on the particle concentration. Therefore, SPD 7 will transmit only a small fraction of any incident light the remaining portion being reflected and scattered.

Where the photodiode 22 indicates that the intensity of ambient light 10 is below a predetermined threshold, the SPD 7 may be switched into a transmissive state, so that the light source 3 can provide backlighting for the LC cell 2. FIG. 4 shows a cell within the SPD 7 when a first voltage V1, which equals or exceeds the saturation potential of the particle suspension 8a, is applied to the electrodes 13, 14 by the control unit 21. The resulting electric field induces a dipole in the particles. In order to minimise the energy of the system, the particles align themselves so that they are parallel to the electric field lines as shown. This increases the transmittance of the particle suspension 8a, so that an increased fraction of incident light 8 is transmitted. When voltage V1 is applied to each of the particle suspensions 8a to 8c, the particle suspension 8 is wholly transmissive, as shown in FIG. 1.

The light 9 emitted by the light source 3 may have a wide angular distribution. However, the aligned particles act to collimate the light passing through the particle suspension 8, so that the resulting backlighting has a relatively narrow angular distribution. This means that a considerable fraction of the light 9 may be scattered by the particles and wasted. The efficiency of the SPD 7 in its transmissive state may be improved by using a suspension liquid with a high refractive index, so that an increased fraction of the light 9 passes through the particle suspension 8. An example of a suitable high refractive index suspension fluid is FC75. FC75 has a refractive index of 1.6, whereas the refractive index of butylacetate is 1.4.

In this example, V1 is an AC voltage, although the same effect may be achieved using a DC voltage instead.

If the photodiode 22 indicates a relatively high level of ambient light 10, above the predetermined threshold, the SPD 7 can be switched into a reflective state, as shown in FIG. 2. This allows the LC cell 2 to be illuminated using reflected ambient light 10.

FIG. 5 shows one cell of the SPD 7 when a second voltage V2, which equais or exceeds the saturation potential of the particle suspension 8a, is applied to ITO layers 16a and 17a. Voltage V2 is an AC voltage, although a DC voltage may be used instead. The reflective particles will tend to align themselves so that they are parallel to the electric field, increasing the reflectance of the particle suspension 8a. Where a second voltage V2 is applied to each of the particle suspensions 8a to 8d, the particle suspension 8 is wholly reflective, as shown in FIG. 2.

Depending on the configuration of the LC cell 2, a quarter-wave plate 5 may be provided in order to ensure that the reflected light 10 is of the correct polarisation to pass through the polariser 6. The quarter-wave plate 5 may be placed between the LC cell 2 and the SPD 7, as depicted in FIG. 2, or between the LC cell 2 and polariser 6.

When the SPD 7 is in the reflective state shown in FIG. 5, the separation between the LC cell 2 and the reflecting surface, that is the surfaces of the particles themselves, may be up to 1 mm. This reduces the resolution of the image when viewed at a wide angle. This effect can be mitigated by switching the SPD 7 into a highly reflective state, when reflected illumination is required. This state is depicted in FIG. 6. The reflectance of a particle suspension 8a is enhanced by applying a first voltage V1, which is a DC voltage, to electrodes 13, 14 in addition to a second voltage V2, which may be an AC or a DC voltage applied to electrodes 16a, 17a, so that two electric fields are applied to a particle suspension 8a simultaneously. Both first and second voltages V1, V2 are equal to, or greater than, the saturation potential. The reflective particles are then attracted towards the plate 11 and cluster in its vicinity, giving the particle suspension 8a a particularly high reflectance. In addition to enhancing the reflectance of the particle suspension 8a, this minimises the distance between the reflecting surfaces and the LC cell 2 so that any deterioration in resolution is reduced.

In this manner, the optical properties of the particle suspension 8 can be controlled by applying voltages V1, V2. Voltages V1, V2 may be used to tune the transmittance and reflectance of the particle suspension 8 to values intermediate to those shown in FIGS. 4 to 6. Such “grey” values may be achieved by, for example, applying one or more voltages V1, V2 that are lower than the saturation potential of the particle suspension 8a, where the resulting, transmittance and reflectance of the particle suspension 8a is determined by the voltage V1, V2.

Another method for achieving a grey value involves applying two or more voltages V1, V2 to the particle suspension 8a in turn, as a series of pulses, in accordance with a suitable driving scheme. The alignments of particles within the particle suspension 8a switch between the field directions of the two electric fields and the effective transmittance and reflectance of the particle suspension 8a is determined by the relative proportions of time that the alignment of the particles is in each of the field directions.

When an applied voltage V1, V2 is switched off, by opening the corresponding switch 19, 20a to 20c, the particles within a particle suspension 8a to 8c are free to undergo Brownian motion and gradually return a state where their alignments are random and variable, as shown in FIG. 3.

The relaxation time of the particle suspensions 8a, 8b, 8c may be considerable. FIG. 8 is a graph of experimental data relating to the transmittance of a suspension of aluminum platelets. At time t=100 s, a voltage V1 is applied as shown in FIG. 4, causing the particle suspension to become transmissive. From the graph, it can be seen that the period of time required for the particles to re-aligned themselves in response to the applied voltage, hereafter referred to as the response time, is within approximately 60 s. At time t=1100 s, the voltage is switched off. The graph shows that, while, when the transmittance decays to approximately 25% of its maximum value after approximately 1000 s. However, the response time and relaxation time of a particular SPD 7 will depend on the properties of the particles and suspension fluid, the volume of the particle suspension, the voltages applied and the driving scheme used to apply the voltages to the particle suspension 8a.

Relaxation times of this order are inappropriate for applications, where rapid changes in the reflectance and transmittance properties of a particle suspension are required. A method of overcoming this drawback will now be described.

When the SPD 4 is in a transmissive state, as shown in FIG. 4, and switch 19 is opened, the electric field perpendicular to the plate 11 and substrate 12 is removed. The particle alignments begin to relax into the disordered state shown in FIG. 3. The relaxation time may be of the order of 15 minutes, as shown in the graph of FIG. 8. However, instead of allowing the particle alignment to decay in this manner, the opening of switch 19 may be followed by the closure of switch 20a, in order to apply an electric field that is parallel to the plate 11 and substrate 12. The particles begin to align themselves along the direction of the newly applied electric field. As the response time is much shorter than the relaxation time, for example, in FIG. 8, the response time is approximately 60 s, the transmittance of the particle suspension 8a will decrease more rapidly. Therefore, in this example, this procedure results in an effective relaxation time of 60 s or less, which is considerably shorter than the time required for the particle alignments to decay through Brownian motion alone.

It is not necessary for voltage V2 to be applied for the full duration of the response time, as the application of the electric field for a shorter time may be sufficient to cause significant deterioration in the uniformity of particle alignment within the cell. If the switch 20a is then opened, the particle alignments will continue to decay into a disordered state under Brownian motion.

As the SPD 7 is split into separate cells, the transmittance and reflectance of the particle suspensions 8a to 8c may be tuned selectively. For example, FIG. 7 shows the SPD 7 when a first voltage V1 is applied to electrodes 13, 14, subjecting particle suspensions 8a, 8b to a first electric field. A second voltage V2 is applied to electrodes 16a, 17a, by closing switch 20a. Switch 20b is left open. This causes particle suspension 8a to be switched into a reflective state, while particle suspension 8b is in a transmissive state. By selectively tuning the particle suspensions 8a to 8c in appropriate cells, the SPD 7 can be used to display an image.

FIG. 9a shows an example where an image 23 of a compact disc is presented on the display 1 by switching a number of cells into a reflective state, as indicated by solid shading. The remaining cells are switched into a transmissive state. The image 23 can also be displayed by switching the relevant cells into a transmissive state and the remaining cells into a reflective state, as shown in FIG. 9b. The resolution of images displayed using the SPD 7 may be of relatively low resolution when compared to those displayed by the LC cell 2.

When the display 1 is switched into standby mode or, if the display 1 is arranged to display a screensaver, the predetermined period of time has expired, an image can be displayed by the transfiector by applying voltages V1, V2 to the particle suspensions 8a to 8c immediately before the power supply to the display 1 is switched off.

In order to obtain an image with good contrast, the SPD 7 should be “reset” by bringing the particles within all the particle suspensions 8a to 8c into the same alignment state before the image is displayed. This is done by applying appropriate voltages to each particle suspension 8a, 8b, 8c. For example, in order to bring the particle suspensions 8a, 8b, 8c into a transmissive state, a voltage V1 must be applied to at least those particle suspensions 8a, 8b, 8c that are in reflective or intermediate states for the duration of the response time.

Where the image displayed by the SPD 7 is to change, the particle suspensions 8a to 8c that are to be tuned to new values of transmittance and reflectance should also be reset before the new image is displayed.

The SPD 7 in this embodiment is a bistable device. Therefore, the SPD 7 can continue to display the image 23 for a significant period of time following the removal of power from the display 1. However, in order to maintain the SPD 7 cells in a given transmissive or reflective state for an extended period of time, one or more appropriate voltages V1, V2 can be applied intermittently. For example, voltage V1 may be initially applied to a particle suspension 8a for a short time period, such as 60 s in the example of FIG. 8, so that the particles are aligned as shown in FIG. 4. The voltage V1 may then be switched off, at which point the uniform particle alignment, and therefore the transmittance, begins to decay. The voltage V1 is then re-applied for 60 s after a predetermined period of time before the transmittance has been significantly degraded, for example, after a 15 minute interval, to “refresh” the particle alignment.

This arrangement allows the optical states of the particle suspensions 8a to 8c, and therefore any image 23 displayed using the SPD 7, to be maintained without requiring a constant electric field. For this reason, the power requirements of the SPD 7 are relatively low when compared with the power required for normal operation of the display 1.

FIG. 10 shows a user interface 24 comprising the transflective display 1 of FIG. 1 and a touch screen arrangement 25. When the display 1 is in standby mode, the SPD 7 is used to display text and/or icons that correspond with touch screen keys, as shown in FIG. 11. In this manner, an image of a keyboard can be maintained without requiring continuous power.

The SPD 7 can also be used to display the touch screen keys during normal operation of the display 1, that is, when the display device 2 is in use. If required, the keys may be displayed using the light source 3 as a backlight for the SPD 7. As the power requirements of the SPD 7 are lower than those of the LC cell 2, such an arrangement may conserve power.

The display may be incorporated in, for example, communication devices or computing equipment, whether fixed or portable.

From reading the present disclosure, other variations and modifications will be apparent to persons skilled in the art. Such variations and modifications may involve equivalent and other features which are already known in the design, manufacture and use of electronic devices comprising liquid crystal displays, alternative display devices or transflectors and component parts thereof and which may be used instead of or in addition to features already described herein.

For example, FIG. 12 shows an alternative transflector 25 that may be used in the display 1 in place of the SPD 7. The transfiector 25 is also a SPD, however, a plurality of electrodes 26a, 26b, 26c are provided on the spacers 15a to 15g enclosing a single particle suspension (not shown). For example, an electric field may be applied to a cell enclosed by spacers 15a and 15b, plate 11 and substrate 12 using electrodes 26a, 26b, 26c on spacer 15a together with corresponding electrodes provided on spacer 15b, which are hidden from view in FIG. 12. Therefore, that cell is effectively divided into three regions that may be subjected to different electric fields. This permits the application of an inhomogenous electric field to the cell, so that the transmittance and reflectance properties of a particle suspension 8a to 8c may vary within a single cell of the SPD 25.

Similarly, one or both of the electrodes 13, 14, located on the plate 11 and substrate 12 respectively, may be divided so that multiple electrodes (not shown) for applying voltage V1 are provided within a cell.

Where multiple electrodes located on the plate 11 and substrate 12 and/or on spacers 15a to 15g are provided within a single cell of a SPD, an active matrix (not shown) may be used to address the individual electrodes 26 etc. This allows greater control over the particle alignment, allowing the transmittance and reflectance of each cell, or each region within a cell to be tuned to intermediate values independently of each other. The displayed image 23 can then also include grey values.

In other embodiments of the invention, the SPD 7 may be replaced with another type of switchable transflector, such as an electrophoretic, electrochromic or metal-hydride switching device. Such transflectors would be configured with cellular structures, similar to those described in relation to SPD 7, in order to enable images to be displayed.

It is not necessary for the transflective display 1 to comprise an LC cell 2. The invention may be implemented using other types of display device, such as micro-mechanical (MEMS) displays, electrowetting, electrochromic or electrophoretic devices.

The particle suspension 8, plate 11, substrate 12 and electrodes 13,14, 16a to 16c, 17a to 17c may be provided using suitable materials other than those mentioned above. For example, the electrodes 13, 14, 16a to 16c, 17a to 17c may be formed using a transparent electrically conductive film of material other than ITO, such as tin oxide (SnO₂). Other suitable materials for electrodes 16a to 16c, 17a to 17c include conducting polymer, silver paste, metals such as copper, nickel, aluminum etc., deposited onto the spacers 15a to 15g by electroplating or printing.

Furthermore, it is not necessary for the SPD 7 to comprise spacers 15a to 15g to define the cells, as shown in the figures. In a further alternative embodiment, the SPD 7 may comprise a film encasing droplets of suspension fluid, the reflective particles being suspended within the droplets. In this arrangement, the cells are defined by the film and the droplets form the individual particle suspensions 8a, 8b, 8c. A similar film-type structure could be used with other types of transfiector whose transmittance and reflectance properties can be controlled using electric fields, such as electrophoretic or electrochromic transflectors. In addition, while the embodiments described comprise a SPD 7 with an array of identical cells, the shapes and sizes of the cells may vary within the SPD 7. For example, if the SPD 7 is intended to display a particular image, such as a set of icons or a logo, the shapes and sizes of the cells may be configured accordingly, in order to minimise the number of switches 19, 20a to 20c in the display 1 and to simplify its control and operation.

Alternatively, the SPD 7 may be configured so that a second voltage V2 can be applied to a group of cells using a single switch 20 in order to display a predetermined image.

In another alternative embodiment of the invention, one or more ITO layers 13, 14 may be formed into discrete electrodes, each of which are associated with a cell. These electrodes may be addressed using an active matrix arrangement. This allows the transmittance and reflectance of each cell to be tuned to intermediate values independently of each other. The displayed image 23 can then also include grey values.

An active matrix arrangement may also be used to tune individual cells or portions of cells where the transfiector comprises one of the types of device listed above, other than a SPD.

The SPD 7 may be configured to maintain an image 23 by applying constant or intermittent electric fields to particle suspensions 8a to 8c. The image 23 may also be displayed on the SPD 7 and simply allowed to decay over the relaxation time, without “refreshing” or maintaining particle alignments.

FIGS. 1, 2 and 10 show a display 1 in which a quarter-wave plate 5 is provided between the SPD 7 and display device 2. As noted above, the quarter-wave plate 5 may instead be provided on the opposite side of the display device 2. However, the quarter-wave 5 plate may also be placed between the SPD 7 and light source 3, although this arrangement results in the quarter-wave plate 5 acting only on light 9 emitted by the light source 3, with no effect on reflected light 10. Alternatively, the quarter-wave plate 5 may be omitted altogether without departing from the scope of the invention.

Instead of being positioned between the display device 2 and light source 3, the transflector can be placed in front of the display device 2, that is, between the display device 2 and a viewer position. When the display device 2 is operating, the transflector is maintained in a transmissive state and the display device 2 is illuminated by the light source 3. In standby mode, the transfiector can be used to display images in the same manner as described above. Alternatively, where a fixed image, such as a logo or unchanging touch screen keys, is to be displayed by the transfiector in standby mode, the transflector may be a SPD in which the reflective particles within each cell are appropriately coloured. When the display 1 is switched into standby mode, the transflector is switched into a reflective state, and the pattern of coloured reflective particles is displayed.

Although Claims have been formulated in this Application to particular combinations of features, it should be understood that the scope of the disclosure of the present invention also includes any novel features or any novel combination of features disclosed herein either explicitly or implicitly or any generalisation thereof, whether or not it relates to the same invention as presently claimed in any Claim and whether or not it mitigates any or all of the same technical problems as does the present invention. The Applicants hereby give notice that new Claims may be formulated to such features and/or combinations of such features during the prosecution of the present Application or of any further Application derived therefrom.

1. A display (1) comprising:
a display device (2); and
a transflector (7);
wherein the transflector (7) comprises a plurality of discrete portions and is configured so that the transmittance and reflectance properties of at least one of said portions can be tuned independently of other portions.

2. A display (1) according to claim 1, wherein the transflector (7) is a bistable device.

3. A display (1) according to claim 1, wherein the transflector (7) is a suspended particle device.

4. A display (1) according to claim 3, wherein said portions include cells containing separate particle suspensions (8a, 8b, 8c).

5. A display (1) according to claim 4, wherein said portions include spatial regions within a compartment containing a particle suspension.

6. A display (1) according to claim 3, wherein the suspended particle device (7) is configured to apply one or more electric fields to a particle suspension (8a, 8b, 8c).

7. A display (1) according to claim 6, wherein at least one of the one or more electric fields is inhomogeneous.

8. A display (1) according to claim 6, wherein at least one of the one or more electric fields is an AC field.

9. A display (1) according to claim 6, wherein at least one of the one or more electric fields is a DC field.

10. A display (1) according to claim 6, wherein the suspended particle device (7) is configured to apply to the particle suspension (8a, 8b, 8c) two electric fields with mutually orthogonal orientations.

11. A display (1) according to claim 6, wherein the suspended particle device (7) is configured so that, following application to the particle suspension (8a, 8b, 8c) of a first electric field in order to cause the particles within the particle suspension (8a, 8b, 8c) to adopt a first particle alignment, a second electric field may be applied to the particle suspension (8a, 8b, 8c) in order to accelerate relaxation of said first particle alignment.

12. A display (1) according to claim 6, further comprising an active matrix of electrodes for selectively applying an electric field to one or more particle suspensions (8a, 8b, 8c).

13. A display (1) according to claim 6, wherein the suspended particle device (7) is configured to apply an electric field to a particle suspension (8a, 8b, 8c) intermittently.

14. A display (1) according to claim 1, wherein physical dimensions of the discrete portions are non-identical.

15. A display (1) according to claim 1, wherein the display device is a liquid crystal cell (2).

16. A display (1) according to claim 15, further comprising a quarter-wave plate.

17. A display (1) according to claim 1, wherein the display device comprises:
an electrophoretic display;
an electrochromic display;
an electro-wetting display; or
a micromechanical display.

18. A display (1) according to claim 1, wherein the transflector is one of:
a switchable mirror display;
an electrochromic display;
an electro-wetting display; and
a roll-blind display.

19. A display (1) according to claim 1, further comprising a light sensor (22).

20. A display (1) according to claim 1, further comprising a touch screen arrangement (25).

21. A user interface (24) comprising a transflective display (1) according to claim 1 and a touch screen arrangement (25).

22. A method of displaying an image (23) on a transflective display (1), which includes a display device (2) and a transflector (7), comprising:
tuning the transmittance and reflectance properties of at least one of a plurality of discrete portions of the transflector (7) independently of other portions.

23. A method according to claim 22, wherein the transflector (7) is a suspended particle device and the step of tuning comprises applying one or more electric fields to a particle suspension (8a, 8b, 8c).

24. A method according to claim 23, wherein said step of tuning comprises applying one or more electric fields to a plurality of separate particle suspensions (8a, 8b, 8c).

25. A method according to claim 23, wherein at least one of said one or more electric fields is an inhomogeneous AC electric field.

26. A method according to claim 23, wherein at least one of said one or more electric fields is an AC field.

27. A method according to claim 23, wherein at least one of said one or more electric fields is a DC field.

28. A method according to claim 23, wherein said step of tuning comprises applying one or more electric fields to the particle suspension (8a) intermittently.

29. A method according to claim 23, wherein at least one of said electric fields has a potential less than a saturation potential of the particle suspension (8a, 8b, 8c).

30. A method according to claim 23, further comprising, following the application of a first electric field in order to cause particles within a particle suspension (8a, 8b, 8c) to adopt a given alignment, applying a second electric field in order to accelerate relaxation of said alignment.

31. A method according to claim 22, wherein the step of tuning the transflector (7) comprises tuning the transmittance and reflectance values of at least one portion in accordance with a level of ambient light (10) detected by a light sensor (22).
